(19) United States
(12) Patent Application Publication
(10) Pub. No.: US 2026/0249855 A1
(43) Pub. Date: Aug. 27, 2026

(54) Method for Hand Detection, Computer Program, and Device

(71) Applicant: Volkswagen Aktiengesellschaft, Wolfsburg (DE)

(72) Inventors: Jonas Kaste, Alfed (Leine) (DE); Felix Stahl, Braunschweig (DE); Felix Kallmeyer, Wolfsburg (DE)

(73) Assignee: Volkswagen Aktiengesellschaft, Wolfsburg (DE)

(21) Appl. No.: 18/879,365

(22) PCT Filed: Jun. 20, 2023
(86) PCT No.: PCT/EP2023/066563

§ 371 Date: Dec. 27, 2024

(30) Foreign Application Priority Data
Jun. 29, 2022 (DE) 10 2022 206 603.0

(51) Int. Cl. B60W 40/08; B60W 50/00

(52) U.S. Cl. CPC B60W 40/08; B60W 50/00; B60W 2050/0029; B60W 2540/223

(57) ABSTRACT

The present disclosure provide methods for improving hand detection on a steering wheel of a vehicle. An example method comprises determining a parameter for evaluating a safety relevance of a situation and carrying out the hand detection on the basis of at least one of a machine learning algorithm and a model-based algorithm on the basis of the parameter.

### CROSS-REFERENCE TO RELATED APPLICATIONS

This application claims priority to German Patent Application DE 10 2022 206 603.0, filed on Jun. 29, 2022 with the German Patent and Trademark Office (. The contents of the aforesaid Patent Application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

Exemplary embodiments relate to a method for hand detection, to a computer program, and to a device. In particular, but not exclusively, exemplary embodiments relate to a method for improving recognition of hand detection on a steering wheel of a vehicle.

Driver assistance systems are intended to situationally support and unburden a vehicle driver and to make the driving task as comfortable and safe as possible. In spite of the ever increasing degree of automation, the driver is still essential for overseeing the systems and the relevant situation as an active part of the control strategy for longitudinal and transverse guidance. One part of this active role is to place the hands on the steering wheel in order to ensure full control and driver-side stabilization of the system quickly in critical situations.

Accordingly, it is necessary to detect the hands on the steering wheel in order to operate different assistance functions in the field of longitudinal and transverse guidance. Integrating a capacitive sensor in the steering wheel resoundingly solves this problem but incurs significant additional costs. One possibility for reducing said costs is to implement a virtual sensor that estimates the gripping of the steering wheel by the driver from available signal curves (e.g. measurable quantities on the steering wheel, such as steering torque, steering wheel angle, steering wheel angular velocity, or vehicle reaction), i.e., said virtual sensor carries out hand detection.

For this purpose, a neural network can be used, for example. However, due to the fact that it has not yet been possible to guarantee the safeguarding of machine learning methods, this method is not suitable for subfunctions with automotive safety integrity level (ASIL) requirements. Another approach is to use classic model-based or mathematical/rule-based approaches. However, due to the complex distinction between driver-induced stimulation on the steering wheel, system-side stimulation, which results, for example, from bumps on the road, as well as system-side friction, these approaches are much less accurate at determining the desired identification of the hands on the steering wheel.

### SUMMARY

A need exists to provide improved hand detection on a steering wheel, for example in particular driving situation, such moving off.

The need is addressed by the subject matter of the independent claim(s). Embodiments of the invention are described in the dependent claims, the following description, and the drawings.

### BRIEF DESCRIPTION OF THE DRAWINGS

FIG. 1 is a schematic representation of an example of a method for improving hand detection on a steering wheel of a vehicle;

FIG. 2 is a block diagram of an example embodiment of a device in a vehicle for improving hand detection on a steering wheel of a vehicle; and

FIGS. 3a-3e show example embodiments for integrating a virtual sensor.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

Exemplary embodiments are based on the core idea that hand detection on a steering wheel of a vehicle can be improved by using a hybrid approach that, depending on the situation, uses at least one algorithm from a machine learning (ML) algorithm or a model-based algorithm (e.g., a classic, mathematical approach) to detect the hands on the steering wheel. As a result, hand detection can be adapted to a situation by means of algorithms, for example. For example, in a safety-critical situation, the hand detection can be determined by means of an algorithm that meets an ASIL requirement (for example a model-based algorithm) . Exemplary embodiments relate to a method for improving hand detection on a steering wheel of a vehicle. The method comprises determining a parameter for evaluating a safety relevance of a situation and carrying out the hand detection on the basis of at least one of a machine learning algorithm and a model-based algorithm on the basis of the parameter. This makes it possible to select an algorithm that is suitable for a relevant situation, for example an algorithm that does not meet the ASIL requirements (for example an ML algorithm) can be selected for a situation that is not safety critical. As a result, accuracy, for example, can be improved.

In some embodiments, the hand detection can be carried out on the basis of the model-based algorithm if the parameter exceeds a limit value. This makes assignment easier for various situations. For example, the limit value can be selected such that the parameter is above the limit value for a safety-critical situation that must meet ASIL requirements.

In some embodiments, the hand detection can be carried out on the basis of the machine learning algorithm if the parameter is below a limit value. This makes assignment easier for various situations. For example, the limit value can be selected such that the parameter is below the limit value for a situation that is not safety-critical and that requires no ASIL requirements.

In some embodiments, the method may further comprise obtaining an item of surroundings information of the vehicle and determining the parameter for evaluating the safety relevance on the basis of the obtained item of surroundings information. As a result, recognition of the safety relevance, in particular, can be improved. For example, a safety-critical situation may be recognized if a moving object (for example a person) comes within a minimum distance from the vehicle (for example in front of the vehicle).

In some embodiments, the method may further comprise obtaining an item of status information relating to a status of the vehicle and determining the parameter for evaluating the safety relevance on the basis of the obtained item of status information. As a result, a speed of the vehicle, for example, can be used to evaluate a situation.

In some embodiments, the method may further comprise obtaining an item of interior information of the vehicle and using the item of interior information for the hand detection. As a result, a reliability of the hand detection can be improved by means of a further input parameter for determining or checking.

Some embodiments also provide a computer program for carrying out one of the methods described herein if the computer program runs on a computer, a processor, or a programmable hardware component.

Some embodiments relate to a device for improving recognition of hand detection on a steering wheel of a vehicle. The device comprises one or more interfaces for communication (e.g., with the sensor for determining surroundings information) and a data processing circuit that is designed to carry out at least one of the methods described herein. Exemplary embodiments further provide a vehicle comprising a device of the like described herein.

Reference will now be made to the drawings in which the various elements of embodiments will be given numerical designations and in which further embodiments will be discussed.

Specific references to components, process steps, and other elements are not intended to be limiting. Further, it is understood that like parts bear the same or similar reference numerals when referring to alternate FIGS. The FIGS. are schematic and not necessarily to scale.

In the FIGS., the thickness dimensions of lines, layers, and/or regions may be represented in an exaggerated manner for the sake of clarity.

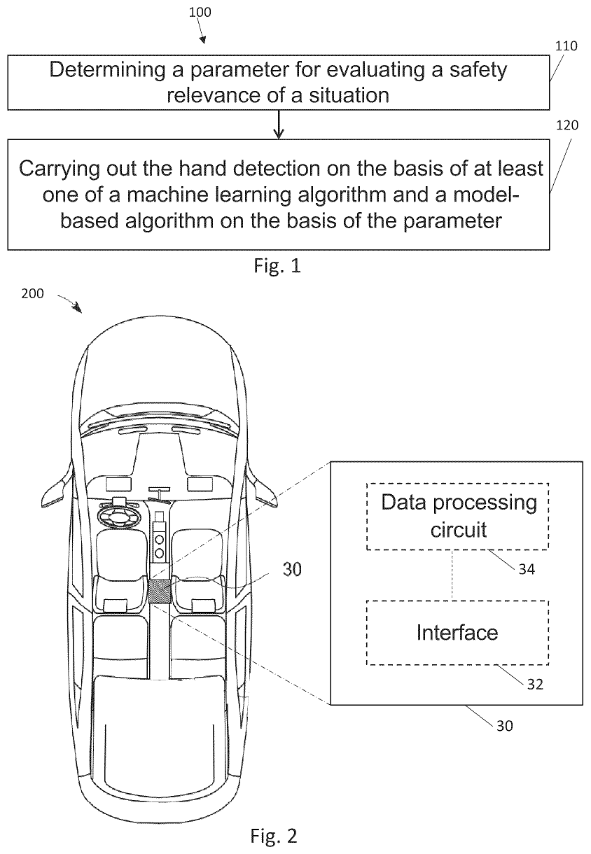

FIG. 1 is a schematic representation of an example of a method 100 for improving hand detection on a steering wheel of a vehicle. The method 100 comprises determining 110 a parameter for evaluating a safety relevance of a situation and carrying out 120 the hand detection on the basis of at least one of a machine learning algorithm and a model-based algorithm on the basis of the parameter. As a result, a selection of an algorithm to be used can be made by means of the parameter. In particular, a suitable algorithm can be selected using the parameter in order, for example, to meet an ASIL requirement. Hand detection can be improved by combining various algorithms, meaning that a capacitive sensor can be dispensed with, thus reducing costs. Even hand detection by means of observation of the vehicle interior, which is prone to errors, can be replaced/avoided or else made more robust.

By using a plurality of algorithms, an algorithm can be adapted to a situation. For example, a first algorithm, e.g., the ML algorithm, may offer a benefit with regard to the accuracy of the determination of the hand detection. The ML algorithm may be sensitive to interferences from outside, e.g. due to stimulation from the roadway, low torques by the driver, friction in the system. This makes it possible to make performance more robust in the event of interferences. Furthermore, improved/more robust performance can be achieved in a broad range of different situations, in particular without an approach that requires manual situation-dependent parameterization.

For example, a second algorithm, e.g., the model-based algorithm, may offer a benefit with regard to determination according to ASIL requirements, because said algorithm is ASIL-compliant.

By selecting one or the synthesis of various algorithms from an ML algorithm and a classic mathematical/model-based algorithm, hand detection, for example hands-off detection (HOD), can be improved. For example, in situations that are not safety-critical, the benefits of non-linear pattern recognition from ML algorithms are utilized. In safety-critical situations and/or when operating critical subfunctions that have an ASIL classification, mathematical/model-based methods that can be safeguarded according to ASIL requirements can be used. By restricting the state space to a subset (for example in that the ML algorithm covers the other subset, depending on the parameter for evaluating the safety relevance) of the operating range, these functions can additionally be optimized depending on the operating point, which can result in a performance gain.

The assessment as to whether a situation is safety-critical or not can be done for every situation in advance. In particular, an assessment for a variety of situations can be stored in a database, for example a look-up table, a file system, or in a data structure. The database may, for example, be stored on a memory unit of a device (see FIG. 2) for carrying out a method according to the teachings herein. For example, a situation can be assigned a value in a value range, wherein a higher value represents a higher criticality of the situation. As a result, various situations can be evaluated in terms of criticality using various parameters. By combining with a limit value, it is then possible, in particular, to make a selection that classifies a situation as safety-critical or not safety-critical. In particular, this selection can be changed by varying the limit values.

By selecting/combining an algorithm, a high-performing, safeguardable, virtual sensor can be realized which reduces the disadvantages of individual approaches and offers a significant cost reduction compared with a real sensor (for example a capacitive sensor). The selection on the basis of the parameter for evaluating the safety relevance can make it possible, in particular, to adapt the individual algorithms to the respective situations, e.g. by defining threshold values.

Furthermore, this makes it possible to provide a purely software-based hand detection solution that can be implemented in a vehicle independently of additional hardware. As a result, a cost reduction, increased safeguardability, increased robustness, and/or a performance gain can be achieved by means of operating point-dependent implementation.

In some embodiments, the hand detection can be carried out on the basis of the model-based algorithm if the parameter exceeds a limit value. As a result, the model-based algorithm can be provided with an associated threshold value, for example for a particular situation, in particular safety-critical situations. In particular, a plurality of model-based algorithms that meet various ASIL requirements may also be used. A selection of a model-based algorithm from a plurality of model-based algorithms can then take place, for example on the basis of the parameter. The limit value may be specific to a situation or a plurality of situations.

In some embodiments, the hand detection can be carried out on the basis of the machine learning algorithm if the parameter is below a limit value. As a result, the ML algorithm can, in particular, only be used for situations which are not safety-critical, i.e., in particular, do not have to meet any ASIL requirements. This makes it possible to take advantage of the higher accuracy of the ML algorithm for situations that are not safety-critical, in particular. In particular, a plurality of ML algorithms that have been trained for various situations may also be used. A selection of an ML algorithm from a plurality of ML algorithms can then take place, for example, on the basis of the parameter.

Alternatively or optionally, a combination of an ML algorithm and a model-based algorithm may also be used. For example, an algorithm, e.g., the ML algorithm, may be used to check the result of the other algorithm, for example of the model-based algorithm.

In some embodiments, the method may further comprise obtaining an item of surroundings information of the vehicle and determining the parameter for evaluating the safety relevance on the basis of the obtained item of surroundings information. As a result, an assessment of a safety-critical situation can be improved.

For example, the item of surroundings information may be obtained by determining information relating to the surroundings by means of one or more sensors of the vehicle and/or by receiving information relating to the surroundings (for example by means of a cooperative awareness message). The item of surroundings information may be received from a vehicle, an infrastructure, a smartphone, a base station, etc. The one or more sensors may, for example, belong to a number of vehicle sensors, e. g., a radar sensor, a lidar sensor, an ultrasonic sensor, or an imaging sensor such as a camera or infrared sensors.

As a result, determination of the safety relevance, in particular, can be improved using the item of surroundings information. For example, in surroundings with few obstacles, moving objects, etc., the safety relevance may be less than in surroundings with more obstacles, moving objects, etc. This makes it possible, in particular, to adaptively adjust the determination the parameter for evaluating the safety relevance.

In some embodiments, the method may further comprise obtaining an item of status information relating to a status of the vehicle and determining the parameter for evaluating the safety relevance on the basis of the obtained item of status information. As a result, a speed of the vehicle, for example, can be taken into account for determining the parameter. For example, a situation may be more critical for a stationary vehicle that is about to move off than for a vehicle traveling on a highway at a speed that is typical for the highway.

In some embodiments, the method may further comprise obtaining an item of status information relating to a status of the vehicle and determining the parameter for evaluating the safety relevance on the basis of the obtained item of status information. As a result, a speed of the vehicle, for example, can be used to evaluate a situation.

In some embodiments, the method may further comprise determining an item of interior information of the vehicle and using the item of interior information for hand detection. Determination may take place, for example, by means of a camera, an infrared camera, etc. The item of interior information can then be used, for example, to verify a result determined by means of the algorithm.

For example, a driver observation camera may be used in order to detect and/or estimate the attentiveness of the driver and/or the position of the hands. However, in addition to the robust development of corresponding image-processing algorithms, it must be ensured that the information from the camera provides robust information in spite of potential concealment or visual interferences.

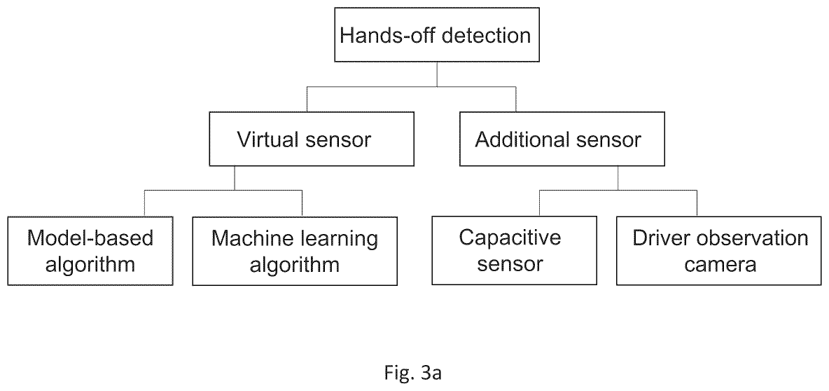

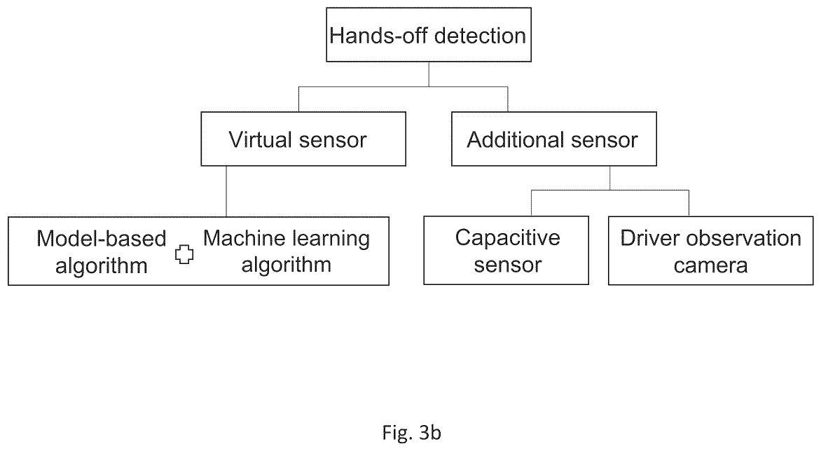

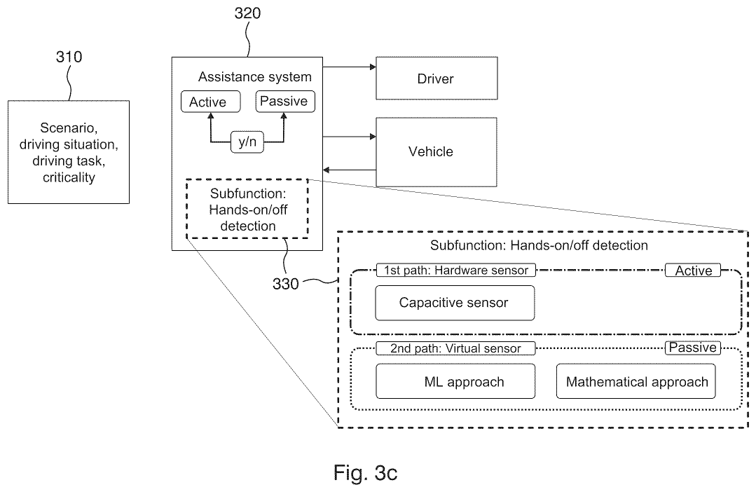

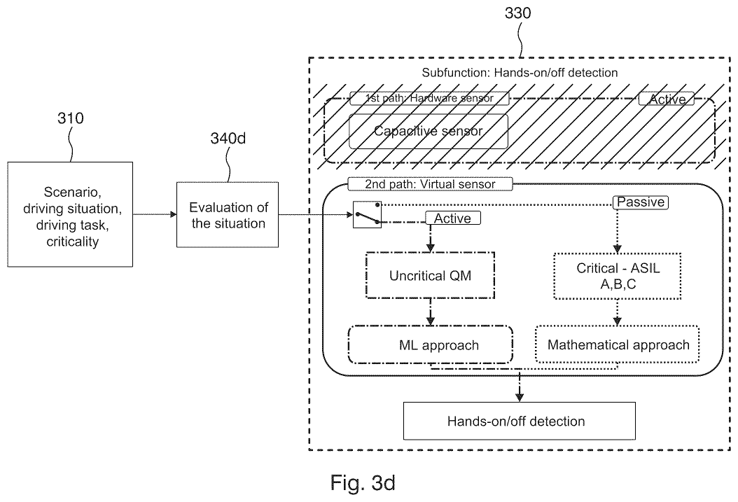

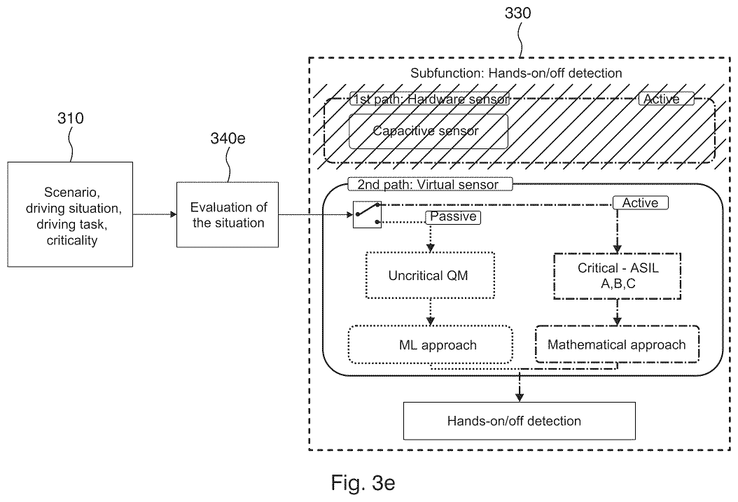

Further details and aspects are explained in connection with the exemplary embodiments described below. The exemplary embodiment shown in FIG. 1 may comprise one or more optional additional features that correspond to one or more aspects that were explained in connection with the proposed concept or one or more exemplary embodiments described below (e. g. FIG. 2 to 3).

FIG. 2 is a block diagram of an exemplary embodiment of a device in a vehicle 200 for improving hand detection on a steering wheel of a vehicle. The device 30 comprises one or more interfaces 32 for communication. The device 30 further comprises a data processing circuit 34 which is designed to carry out at least one of the methods described herein, for example the method described with reference to FIG. 1. Further exemplary embodiments relate to a vehicle having a device 30.

The one or more interfaces 32 may, for example, correspond to one or more inputs and/or one or more outputs for receiving and/or transmitting information, for example in digital bit values, based on a code, within a module, between modules, or between modules of different entities. The at least one or more interfaces 32 may, for example, be designed to communicate with other network components via a (wireless) network or a local connection network.

As shown in FIG. 2, the one or more interfaces 32 are coupled to the relevant data processing circuit 34 of the device 30. In examples, the device 30 may be implemented by one or more processing units, one or more pieces of processing equipment, any desired means for processing, for example a processor, a computer, or a programmable hardware component that can be operated with accordingly adapted software. Equally, the functions of the data processing circuit 34 described may also be implemented in software which is then run on one or more programmable hardware components. Hardware components of this kind may be a multi-purpose processor, a digital signal processor (DSP), a microcontroller, etc. The data processing circuit 34 may be capable of controlling the one or more interfaces 32, such that every data transmission that takes place via the one or more interfaces 32 and/or every interaction in which the one or more interfaces 32 may be involved can be controlled by the data processing circuit 34.

In some embodiments, the data processing circuit 34 may correspond to any desired controller or processor or programmable hardware component. For example, the data processing circuit 34 may also be realized as software which is programmed for a corresponding hardware component. Consequently, the data processing circuit 34 can be implemented as programmable hardware with accordingly adapted software. Any desired processors, such as digital signal processors (DSPs), may be used here. Exemplary embodiments are not limited to a particular type of processor. Any desired processors or multiple processors are conceivable for implementing the data processing circuit 34.

In some embodiments, the device 30 may comprise a memory and at least one data processing circuit 34 that is functionally coupled to the memory and is configured to carry out the method described below.

In examples, the one or more interfaces 32 may correspond to any means for obtaining, receiving, transmitting, or providing analog or digital signals or information, e.g. any connection, contact, pin, register, input connection, output connection, conductor, track, etc., makes it possible to provide or obtain a signal or an item of information. The one or more interfaces 32 may be wireless or wired and may be configured such that they can communicate with further internal or external components, e.g. send or receive signals or information.

In at least some exemplary embodiments, the vehicle may, for example, correspond to a land vehicle, a watercraft, an aircraft, a rail vehicle, a road vehicle, a car, a bus, a motorcycle, an off-road vehicle, a motor vehicle, or a truck. The data processing circuit may, for example, be part of a control unit of the vehicle.

Further details and aspects are explained in connection with the exemplary embodiments described above and/or below. The exemplary embodiment shown in FIG. 2 may comprise one or more optional additional features that correspond to one or more aspects that were explained in connection with the proposed concept or one or more exemplary embodiments described above (e. g. FIG. 1) and/or below (e.g. FIG. 3).

FIG. 3 shows various examples of hands-off detection. FIG. 3a shows various HOD concepts known from the prior art. For example, a cost-effective virtual sensor or an additional sensor that is associated with higher costs may be used. The use of virtual sensors can be divided into model-based algorithms (ASIL-compatible) and ML algorithms (enhanced performed thanks to better consideration of environmental influences such as friction, stimulation back from the road, etc.). With regard to additional sensors, capacitive sensors (ASIL-compatible) or driver observation cameras (suitable for a variety of purposes) may be used.

FIG. 3b shows an exemplary embodiment of a hybrid approach that uses machine learning methods or classic, mathematical model-based approaches for HOD depending on the £ situation. The combination of both algorithms/approaches based on a situation-dependent parameter can make it possible to utilize improved performance of the ML algorithm and can also allow for situation-dependent safeguarding, for example according to ASIL, of the model-based algorithm.

FIG. 3c shows an exemplary embodiment of modeling for a virtual sensor. Vehicle reactions, or else movement information (e.g., speed, yaw rate, lateral acceleration), an output from an assistance system (e.g., desired curvature, supporting torque, desired steering angle), an item of steering wheel information (e. g., steering angle, steering angular velocity, steering torque) can be used as training data for the ML algorithm. Data from vehicles having integrated capacitive hardware sensors can be used as evaluation data (ground truth) for a result of the ML algorithm. In particular, these integrated hardware sensors can be replaced with the use of a virtual sensor consisting of the combination of ML and model-based algorithms. In a first step, modeling for the virtual sensor may take place. For this purpose, hardware sensors (for example of other vehicles), in particular, can be used. Said hardware sensors may provide training data, in particular ground truth data, on the basis of which a software-based solution can be developed and, optionally, tested.

A system for training algorithm may be configured to provide information (training input data) relating to vehicle reactions, or else movement information (e.g., speed, yaw rate, lateral acceleration), an output from an assistance system (e. g., desired curvature, supporting torque, desired steering angle), an item of steering wheel information (e.g., steering angle, steering angular velocity, steering torque) as the input for a machine learning model. Machine learning relates to algorithms and statistical models that computer systems can use to execute a particular task without explicit instructions and instead rely on models and inferences. For example, in machine learning, instead of rule-based data conversion, data conversion that is derived from an analysis of historical and/or training data may be used.

Machine learning models are trained based on training data. A wide variety of approaches can be used to train a machine learning model. For example, supervised learning, semi-supervised learning, or unsupervised learning may be used. In supervised learning, the machine learning model is trained using a multitude of training patterns, wherein each pattern may comprise a multitude of input data values and a multitude of desired output values, e. g., every training pattern is associated with a desired value. By specifying both training patterns and desired output values, the machine learning model “learns” which output value to provide on the basis of an input pattern that is similar to the patterns provided during the training. In addition to supervised learning, semi-supervised learning may also be used. In semi-supervised learning, some of the training patterns lack a corresponding desired output value. Supervised learning may be based on a supervised learning algorithm, e. g., a classification algorithm, a regression algorithm, or a similarity learning algorithm. In unsupervised learning, (only) input data can be provided, and an unsupervised learning algorithm can be used to find a structure in the input data, e.g., by grouping or clustering the input data in order to find commonalities in the data.

The machine learning model may, for example, be an artificial neural network (ANN). ANNs are systems which are based on biological neural networks found, for example, in the brain. ANNs consist of a multitude of interconnected nodes and a multitude of connections, so-called edges, between the nodes. As a general rule, there are three types of node: Input nodes, which receive input values, hidden nodes, which are connected to other nodes, and output nodes, which provide output values. Each node can constitute an artificial neuron. Each edge can transmit information from one node to another. The output of a node can be defined as a (non-linear) function of the sum of its inputs. The inputs of a node can be used in the function on the basis of a “weight” of the edge or of the node providing the input. The weighting of nodes and/or edges can be adjusted during the learning process. In other words, the training of an artificial neural network may include adjusting the weights of the nodes and/or edges of the artificial neural network, e.g. in order to achieve a desired output for a given input. In at least some examples, the machine learning model may be a deep neural network, e.g. a neural network having one or more layers of hidden nodes (e. g. hidden layers), for example a large number of layers of hidden nodes.

The training of machine learning models requires considerable effort, and therefore reusing a machine learning model for various problem sizes can reduce the overall training time. In various examples of the present disclosure, the machine learning model can be applied to a different number of device or else vehicles.

The training input data may, for example, be obtained via an interface, e.g., an interface of the system. The training input data can be obtained from a database, from a file system, or from a data structure that is stored in a computer memory. The training input data may include training information relating to vehicle reactions, or else movement information (e.g., speed, yaw rate, lateral acceleration), an output from an assistance system (e.g., desired curvature, £ supporting torque, desired steering angle), an item of steering wheel information (e. g., steering angle, steering angular velocity, steering torque). The term “training information” may merely indicate that the respective data are suitable, e. g., designed, for training the machine learning model. For example, the training information may include information relating to vehicle reactions, or else movement information (e.g., speed, yaw rate, lateral acceleration), an output from an assistance system (e.g. desired curvature, supporting torque, desired steering angle), an item of steering wheel information (e.g., steering angle, steering angular velocity, steering torque) that are representative of the respective data to be processed by the machine learning model, e.g., in order to obtain a machine learning model that is suitable for the present task, e.g., suitable for hand detection on a steering wheel.

For example, the machine learning model may provide an item of information that relates to hand detection and that is based on the training information of the like described above that can be provided at the input of the machine learning model. In other words, the machine learning model can be provided with the training input data, which are formed of a multitude of parameters for assessing a hand detection, and with the task of improving hand detection.

The machine learning model can be trained, for example, by carrying out a group of training tasks (or method steps) repeatedly (e.g., at least twice, at least five times, at least ten times, at least 20 times, at least 50 times, at least 100 times, at least 1000 times). For example, the machine learning model can be trained by inputting the training input data repeatedly into the machine learning model, carrying out hand detection, evaluating the hand detection on the basis of the ground truth of a hardware sensor, and adjusting the machine learning model on the basis of a result of the evaluation.

A repetition of the above-mentioned tasks can be referred to in reinforcement learning as an “epoch”. An epoch means that the entire set of training input data is passed once forwards and backwards through the machine learning model. A large number of stacks of training data can be input into the machine learning model within an epoch in order to determine a hand detection. In order to keep the problem size small, the training data can, for example, be divided into a multitude of stacks which can be provided to the machine learning model separately. Each stack from the multitude of stacks can be input separately into the machine learning model.

As can be seen in FIG. 3c, an item of information (a scenario, a driving situation, a driving task, a criticality, etc.) can be provided in 310 in order to determine a situation. This item of information may, for example, be used to determine the parameter for evaluating a safety relevance of a situation. An assistance system 320 may comprise a subfunction 330 for HOD. A hardware sensor may be present for training the ML algorithm, which hardware sensor provides evaluation data for the ML algorithm. As a result, modeling of the ML algorithm can be improved on the basis of evaluation data. The assistance system 320 may then, for example, output an item of information to a driver, for example a warning that said driver should put their hands on the steering wheel and/or carry out control of the vehicle, for example a braking procedure, aborting a maneuver, etc. (for example if no hands were detected on the steering wheel in a critical situation).

After the ML algorithm has been trained, it can be used in synergy with a model-based algorithm. As shown in FIGS. 3d and 3e, a relevant algorithm can be used depending on an evaluation of a situation 340d, 340e. In FIG. 3d, the provision 310 of the item of information leads to an evaluation of the situation 340d as a situation that is not safety-critical. Accordingly, in the subfunction 330, an ML approach, i.e. an ML algorithm, is used for HOD. This algorithm can offer improved performance. As already explained, the assessment of a criticality of situation may take place in advance and then by means of comparison with a database, a file system, or from a data structure.

In FIG. 3e, the provision 310 of the item of information leads to an evaluation of the situation 340e as a situation that is safety-critical. Accordingly, in the subfunction 330, a mathematical approach, i.e., a model-based algorithm, is used for HOD. This algorithm can, in particular, meet ASIL requirements.

By using the 2nd path with the virtual sensor, the 1st path with the hardware sensor can be dispensed with. As a result, there is no need for an expensive hardware sensor, as a result of which, in particular, costs can be saved.

Further details and aspects are explained in connection with the exemplary embodiments described above. The exemplary embodiment shown in FIG. 3 may comprise one or more optional additional features that correspond to one or more aspects that were explained in connection with the proposed concept or one or more exemplary embodiments described above (e.g., FIG. 1 to 2).

Further exemplary embodiments relate to computer programs for carrying out a method described herein if the computer program runs on a computer, a processor, or a programmable hardware component. Depending on particular implementation requirements, exemplary embodiments can be implemented in hardware or software. The implementation can be done using a digital storage medium, for example a floppy disk, a DVD, a Blu-ray Disc, a CD, a ROM, a PROM, an EPROM, an EEPROM, or a FLASH memory, a hard drive, or another magnetic or optical memory on which electronically readable control signals are stored £ which interact or can interact with a programmable hardware component in such a way that the relevant method is carried out.

A programmable hardware component may be in the form of a processor, a computer processor (CPU =central processing unit), a graphic processor (GPU =graphics processing unit), a computer, a computer system, an application-specific integrated circuit (ASIC), an integrated circuit (IC), a system on a chip (Soc), a programmable logic element, or a field-programmable gate array (FPGA) with a microprocessor.

The digital storage medium may therefore be machine-or computer-readable. Some embodiments thus include a data carrier having electronically readable control signals which are capable of interacting with a programmable computer system or programmable hardware component in such a way that one of the methods described herein is carried out. One exemplary embodiment is therefore a data carrier (or digital storage medium or computer-readable medium) on which the program for carrying out one of the methods described herein is recorded.

Generally, exemplary embodiments of the teachings herein can be implemented as a program, firmware, a computer program or computer program product with a program code, or as data, wherein the program code or the data is or are effective at carrying out one of the methods if the program runs on a processor or a programmable hardware component. The program code or the data may, for example, also be stored on a machine-readable carrier or data carrier. The program code or the data may, inter alia, be in the form of source code, machine code, or byte code, as well as another intermediate code.

The above-described exemplary embodiments merely illustrate the principles of the present disclosure. It should be understood

That modifications and variations of the arrangements and details described herein would be apparent to a person skilled in the art. Therefore, the invention is merely intended to be limited by the scope of protection of the claims below and not by the specific details presented herein on the basis of the description and the explanation of the exemplary embodiments.

### LIST OF REFERENCE NUMERALS

30 Device
32 Interface
34 Data processing unit
100 Method for improving hand detection on a steering wheel
110 Determining a parameter for evaluating a safety relevance of a situation
120 Carrying out the hand detection
200 Vehicle
310 Information for determining a situation
320 Assistance system
330 Subfunction for hand detection
340d, 340e Evaluation of the situation

The invention has been described in the preceding using various example embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the functions of several items recited in the claims.

The term “exemplary” used throughout the specification means “serving as an example, instance, or exemplification” and does not mean “preferred” or “having advantages” over other embodiments. The terms “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1-10. (canceled)

11. A method for automatic improved hand detection on a steering wheel of a vehicle, comprising:
determining a parameter for evaluating a safety relevance of a situation; and
carrying out the hand detection on the basis of at least one of a machine learning algorithm and a model-based algorithm on the basis of the parameter.

12. The method of claim 11, wherein the hand detection is carried out on the basis of the model-based algorithm if the parameter exceeds a threshold value.

13. The method of claim 11, wherein the hand detection is carried out on the basis of the machine learning algorithm if the parameter is below a threshold value.

14. The method of claim 11, further comprising:
obtaining an item of surroundings information of the vehicle; and
determining the parameter for evaluating the safety relevance on the basis of the obtained item of surroundings information.

15. The method of claim 11, further comprising:
obtaining an item of status information relating to a status of the vehicle; and
determining the parameter for evaluating the safety relevance on the basis of the obtained item of status information.

16. The method of claim 11, further comprising:
determining an item of interior information of the vehicle; and
using the item of interior information for the hand detection.

17. The method of claim 16, wherein the hand detection is carried out on the basis of the item of interior information and the machine learning algorithm if the parameter exceeds a threshold value.

18. A non-transitory storage medium comprising instructions, that when executed on a computer, a processor, or a programmable hardware component provide:
determining a parameter for evaluating a safety relevance of a situation; and
carrying out the hand detection on the basis of at least one of a machine learning algorithm and a model-based algorithm on the basis of the parameter.

19. A device for improving recognition of hand detection on a steering wheel of a vehicle, comprising:
one or more interfaces for communication; and
a data processing circuit which is configured to control the one or more interfaces and to:
determine a parameter for evaluating a safety relevance of a situation; and
carry out the hand detection on the basis of at least one of a machine learning algorithm and a model-based algorithm on the basis of the parameter.

20. A vehicle comprising the device of claim 19.

21. The device of claim 19, wherein the hand detection is carried out on the basis of the model-based algorithm if the parameter exceeds a threshold value.

22. The device of claim 19, wherein the hand detection is carried out on the basis of the machine learning algorithm if the parameter is below a threshold value.

23. The device of claim 19, further comprising:
obtaining an item of surroundings information of the vehicle; and
determining the parameter for evaluating the safety relevance on the basis of the obtained item of surroundings information.

24. The device of claim 19, further comprising:
obtaining an item of status information relating to a status of the vehicle; and
determining the parameter for evaluating the safety relevance on the basis of the obtained item of status information.

25. The device of claim 19, further comprising:
determining an item of interior information of the vehicle; and
using the item of interior information for the hand detection.

26. The device of claim 19, wherein the hand detection is carried out on the basis of the item of interior information and the machine learning algorithm if the parameter exceeds a threshold value.

27. The method of claim 12, wherein the hand detection is carried out on the basis of the machine learning algorithm if the parameter is below a threshold value.

28. The method of claim 12, further comprising:
obtaining an item of surroundings information of the vehicle; and
determining the parameter for evaluating the safety relevance on the basis of the obtained item of surroundings information.

29. The method of claim 13, further comprising:
obtaining an item of surroundings information of the vehicle; and
determining the parameter for evaluating the safety relevance on the basis of the obtained item of surroundings information.

30. The method of claim 12, further comprising:
obtaining an item of status information relating to a status of the vehicle; and
determining the parameter for evaluating the safety relevance on the basis of the obtained item of status information.
